(19) United States
(12) Patent Application Publication
(10) Pub. No.: US 2005/0220309 A1
(43) Pub. Date: Oct. 6, 2005

(54) Sound reproduction apparatus, sound reproduction system, sound reproduction method and control program, and information recording medium for recording the program

(76) Inventors: Mikiko Hirata, Tokorozawa-shi (JP); Akihisa Yamaguchi, Tokorozawa-shi (JP); Junichi Imamura, Tokorozawa-shi (JP); Jun Peng, Tokorozawa-shi (JP); Susumu Yamamoto, Tokorozawa-shi (JP)

Correspondence Address: Richard P. Berg, Esq.;c/o LADAS & PARRY, Suite 2100, 5670 Wilshire Boulevard, Los Angeles, CA, 90036-5679, US

(21) Appl. No.: 11/090,912

(22) Filed: Mar. 24, 2005

(30) Foreign Application Priority Data
Mar. 30, 2004 (JP) P2004-101045

(51) Int. Cl. H04R 5/00; H04R 5/02

(52) U.S. Cl. 381/18; 381/19; 381/307

(57) ABSTRACT

In a recording unit, a set state table in which various parameters which are required are stored when a sound processing unit performs signal processing for audio data that corresponds to each channel, and a setting screen data are recorded. This setting screen data is linked to the set state table, so that the set state table is altered in accordance with alteration performed on this setting screen. As a result, the parameters that are used when the sound processing unit performs signal processing for audio data are altered.

### BACKGROUND OF THE INVENTION

1. Field of the Invention

The present invention relates to a sound reproduction apparatus equipped with a plurality of sound sources and, more particularly to, a method of setting a sound reproduction apparatus when reproducing an audio signal.

2. Description of the Related Art

Recently, with an increasing capacity of a recording medium such as a DVD, a variety of sound reproducing apparatuses such as an AV amplifier that reproduces a plurality of channels of audio data have been provided. In this type of sound reproduction apparatus, it is preferable to normally position a sound image to be reproduced to a listening point of a listener and recreate a sound field appropriately. For this purpose, this type of sound reproduction apparatus is provided with a function to change output timing and volume of sound to be produced by each speaker, based on a distance from the speaker to the listening point.

To decide parameters such as the output timing in a conventional sound reproduction apparatus, the following methods have been proposed.

<Method 1>

By entering a distance from a new listening point to the speaker on a setting screen, the parameters such as the output timing are decided in accordance with this set value.

<Method 2>

By outputting, for example, pink noise or white noise from each speaker as measuring signal sound, the parameters such as the output timing are calculated on the basis of results of detecting a measuring signal by a microphone located at the listening point (see Japanese Patent Application Laid-Open No. 2002-330499). The corresponding U.S. 2002159605A1 is incorporated by reference in its entirety.

Supposing that a user has cleaned a room in which a sound reproduction apparatus is placed, there may often occur such a situation that a location of a sofa that has served as a listening point is changed or that a location of a speaker is changed. In such a case, in order to recreate an optimal sound field, it is necessary to change parameters such as the above-described output timing in accordance with a distance between a new listening point and a sound source.

However, by a conventional setting method in accordance with the above-described method 1, it is necessary to measure the distance between each speaker and the listening point by using, for example, a measuring tape and enter a measurement result thus obtained on the setting screen. Therefore, complexities are unbearable of repeating the same job each time the listening point etc. is changed in such a situation as described above.

In accordance with the above-described method 2, on the other hand, the complexities can be eliminated because it is unnecessary to use the measuring tape in measurement of the distance. However, by this method 2, noise in surroundings causes fluctuations in detection results, so that if the sound reproduction apparatus is placed in an environment such as a living room subject to noise and comings and goings of persons, an opportunity is limited for making settings. It has been, therefore, difficult by the above method 2 to change the parameters each time the listening point is changed.

### SUMMARY OF THE INVENTION

In view of the above, the present invention has been developed, and it is one object of the present invention to provide a sound reproduction apparatus, a sound reproduction system, a sound reproduction method and control program, and an information recording medium for recording this program in which it is possible to easily generate an optimal sound field without performing a complex process when a position of listening point or a position where a speaker is arranged is changed.

The invention according to claim 1 relates to a sound reproduction apparatus for causing each of speakers that corresponds to each of a plurality of audio signals to loud-speak based on the plurality of audio signals, the apparatus comprising:
a display control device that causes a display device to display a setting screen which is a screen to display a virtual space that recreates the sound field space and on which a selected image is drawn at a listening position of the listener and a location that corresponds to a position where each of the speakers is arranged in the sound field space and that alters the setting screen in accordance with an input operation performed by a user based on the setting screen;
a recognition device which recognizes a set state of each of the speakers and a set state of the listening position in the virtual space based on the setting screen;
a calculation device which calculates an actual distance between each of the speakers and the listening position in the sound field space based on a result of the recognition; and
a sound processing device which performs signal processing for the audio signals that corresponds to the calculated distance.

It is possible to provide a sound reproduction system comprising a plurality of speakers and a sound reproduction apparatus for causing each of the speakers that corresponds to each of a plurality of audio signals to loud-speak based on the plurality of audio signals so that a sound field space having a sense of reality is provided to a listener,
wherein the sound reproduction apparatus comprises:
a display control device that causes a display device to display a setting screen which is a screen to display a virtual space that recreates the sound field space and on which a selected image is drawn at a listening position of the listener and a location that corresponds to a position where each of the speakers is arranged in the sound field space and that alters the setting screen in accordance with an input operation performed by a user based on the setting screen;
a recognition device which recognizes a set state of each of the speakers and a set state of the listening position in the virtual space based on the setting screen;
a calculation device which calculates an actual distance between each of the speakers and the listening position in the sound field space based on a result of the recognition; and
a sound processing device which performs the signal processing that corresponds to the calculated distance for the audio signals.

It is possible to provide a sound reproduction system comprising a plurality of speakers, a sound reproduction apparatus for causing each of the speakers that corresponds to each of a plurality of audio signals to loud-speak based on the plurality of audio signals so that a sound field space having a sense of reality is provided to a listener, and an information processing apparatus for performing various kinds of signal processing, wherein the information processing apparatus comprises:
a display control device that causes a display device to display a setting screen which is a screen to display a virtual space that recreates the sound field space and on which a selected image is drawn at a listening position of the listener and a location that corresponds to a position where each of the speakers is arranged in the sound field space and that alters the setting screen in accordance with an input operation performed by a user based on the setting screen;
a recognition device which recognizes a set state of each of the speakers and a set state of the listening position in the virtual space based on the setting screen;
a calculation device which calculates an actual distance between each of the speakers and the listening position in the sound field space based on a result of the recognition; and
a control device which controls the sound reproduction apparatus in accordance with a result of the calculation; and
the sound reproduction apparatus comprises:
a sound processing device which performs the signal processing that corresponds to the calculated distance for the audio signals under the control of the information processing apparatus.

The invention according to claim 10 relates to a method of reproducing sound in a sound reproduction system comprising a plurality of speakers and a sound reproduction apparatus for causing each of the speakers that corresponds to each of a plurality of audio signals to loud-speak based on the plurality of audio signals, the method comprising:
a first process, by the sound reproduction apparatus, which causes a display device to display a setting screen which is a screen to display a virtual space that recreates the sound field space and on which a selected image is drawn at a listening position of the listener and a location that corresponds to a position where each of the speakers is arranged in the sound field space;
a second process, by the sound reproduction apparatus, which alters the setting screen in accordance with an input operation performed by a user based on the setting screen;
a third process, by the sound reproduction apparatus, which recognizes a set state of each of the speakers and a set state of the listening position in the virtual space based on the setting screen;
a fourth process, by the sound reproduction apparatus, which calculates an actual distance between each of the speakers and the listening position in the sound field space based on a result of the recognition; and
a fifth process, by the sound reproduction apparatus, which performs the signal processing that corresponds to the calculated distance for the audio signals.

The invention according to claim 11 relates to a method of reproducing sound in a sound reproduction system comprising a plurality of speakers, a sound reproduction apparatus for causing each of the speakers that corresponds to each of a plurality of audio signals to loud-speak based on the plurality of audio signals, and an information processing apparatus for performing various kinds of signal processing, the method comprising:
an eleventh process, by the information processing apparatus, which causes a display device to display a setting screen which is a screen to display a virtual space that recreates the sound field space and on which a selected image is drawn at a listening position of the listener and a location that corresponds to a position where each of the speakers is arranged in the sound field space;
a twelfth process, by the information processing apparatus, which alters the setting screen in accordance with an input operation performed by a user based on the setting screen;
a thirteenth process, by the information processing apparatus, which recognizes a set state of each of the speakers and a set state of the listening position in the virtual space based on the setting screen;
a fourteenth process, by the information processing apparatus, which calculates an actual distance between each of the speakers and the listening position in the sound field space based on a result of the recognition;
a fifteenth process, by the information processing apparatus, which controls the sound reproduction apparatus in accordance with a result of the calculation; and
a sixteenth process, by the sound reproduction apparatus, which performs the signal processing that corresponds to the calculated distance for the audio signals under the control of the information processing apparatus.

It is possible to provide a computer-readable information recording medium in which a control program is recorded for causing a computer to control a sound reproduction apparatus for causing each of speakers that corresponds to each of a plurality of audio signals to loud-speak based on the plurality of audio signals so that a sound field space having a sense of reality is provided to a listener, the program causing the computer to function as:
a display control device that causes a display device to display a setting screen which is a screen to display a virtual space that recreates the sound field space and on which a selected image is drawn at a listening position of the listener and a location that corresponds to a position where each of the speakers is arranged in the sound field space and that alters the setting screen in accordance with an input operation performed by a user based on the setting screen;
a recognition device which recognizes a set state of each of the speakers and a set state of the listening position in the virtual space based on the setting screen;
a calculation device which calculates an actual distance between each of the speakers and the listening position in the sound field space based on a result of the recognition; and
a control device which controls the sound reproduction apparatus in accordance with a result of the calculation.

### BRIEF DESCRIPTION OF THE DRAWINGS

FIG. 1 is a block diagram of a configuration of a sound reproduction system SY of an embodiment;

FIG. 2 shows one example of contents recorded in a parameter table TBL1-k of the same embodiment;

FIG. 3 shows one example of contents recorded in a setting state table TBL2 of the same embodiment;

FIG. 4 shows one example of an image which is displayed on the basis of setting screen data of the same embodiment;

FIG. 5 is a flowchart of processing which is performed by a system control unit 5 in a sound reproduction apparatus A of the same embodiment;

FIG. 6 shows one example of an image which is displayed on a monitor MN of the same embodiment;

FIG. 7 is a flowchart of the processing which is performed by the system control unit 5 in the sound reproduction apparatus A of the same embodiment;

FIG. 8 is a flowchart of the processing which is performed by the system control unit 5 in the sound reproduction apparatus A of the same embodiment;

FIG. 9 is a flowchart of the processing which is performed by the system control unit 5 in the sound reproduction apparatus A of the same embodiment;

FIG. 10 shows one example of an image which is displayed on a monitor MN of the same embodiment; and

FIG. 11 shows a configuration of a sound reproduction system SY1 of a variant 2.

### DESCRIPTION OF THE PREFERRED EMBODIMENTS

The following will describe an embodiment of the present invention with reference to the drawings. It is to be noted that the related embodiments are not restrictive and can be changed arbitrarily within a scope of the technical concept of the present invention.

### [1] Embodiment

### [1.1] Outline of Embodiment

(1) Configuration of Sound Reproduction System Related to this Embodiment

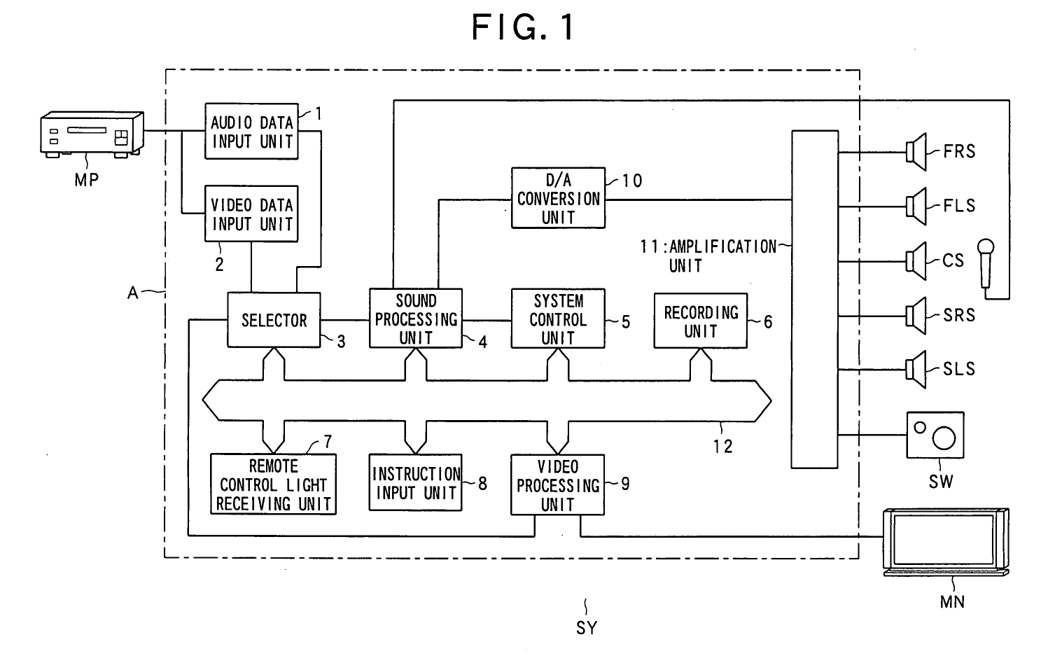

First, the following will describe a sound reproduction system SY related to the present embodiment, with reference to FIG. 1. FIG. 1 shows a configuration example of a system S in a case where a sound reproduction apparatus A is an AV amplifier.

As shown in the figure, the sound reproduction system SY related to the present embodiment comprises a monitor MN for displaying various kinds of image, a medium playback apparatus MP such as a DVD recorder, a front right speaker FRS, a front left speaker FLS, a center speaker CS, a surround right speaker SRS, a surround left speaker SLS (hereinafter referred to as “speaker S” simply if there is no need to specify each speaker S), a subwoofer SW, and a sound reproduction apparatus A.

In the sound reproduction system SY related to the present embodiment, video data and audio data read by the medium playback apparatus MP from a recording medium such as a DVD are supplied to the sound reproduction apparatus A. The sound reproduction apparatus A, in turn, outputs the video data supplied from this medium reproduction apparatus MP to the monitor MN and performs signal processing for the audio data and outputs it to each of the speakers S. As a result of the sound reproduction apparatus A performing the signal processing, a sound image is positioned normally to a listening point, to recreate an optimal sound field.

To realize such a function, in the present embodiment, the sound reproduction apparatus A comprises an audio data input unit 1, a video data input unit 2, a selector 3, a sound processing unit 4, a system control unit 5, a recording unit 6, a remote control light receiving unit 7, an instruction input unit 8, a video processing unit 9, a digital/analog conversion unit (hereinafter abbreviated as “D/A”) 10, an amplification unit 11, and a data bus 12 for connecting these components to each other.

It is to be noted that, for example, this system control unit 5 corresponds to “recognition device” and “calculation device” in “WHAT IS CLAIMED IS” and “recording device” corresponds to the recording unit 6. Further, for example, “sound processing device” in “WHAT IS CLAIMED IS” is realized when the system control unit 5 and the sound processing unit 4 cooperates and “display control device” is realized when the system control unit 5 and the video processing unit 9 cooperate.

To begin with, the audio data input unit 1 and the video data input unit 2 each have a plurality of digital signal input terminals such as a D4 terminal, to output to the selector 3 audio data and video data supplied from the medium playback apparatus MP through these terminals. It is to be appreciated that although it is arbitrary what channel of audio data is to be supplied to the audio data input unit 1, in the present embodiment, description is made on the assumption that audio data is supplied as much as 5.1 channels of five channels containing a front right (hereinafter abbreviated as “FR”) channel, a front left (hereinafter abbreviates as “FL”) channel, a center (hereinafter abbreviated as “C”) channel, a surround right (hereinafter abbreviated as “SR”) channel, and a surround left “hereinafter abbreviated as “SL”) channel, plus one low frequency effect (LFE) channel.

The selector 3 selects each of data supplied to the respective terminals of the audio data input unit 1 and the video data input unit 2 in accordance with an input operation of a user and outputs this selected data to the sound processing unit 4 and the video processing unit 9.

The remote control light receiving unit 7, which is constituted of, for example, a light receiving element, receives a control signal transmitted in infrared light from a remote control apparatus, not shown, and outputs this received control signal to the data bus 12. The instruction input unit 8, which has a cursor key and other various keys for permitting the selector 3 to select signals, outputs such a control signal as to be in accordance with a user's input operation to the system control unit 5 via the data bus 12.

The video processing unit 9 outputs to the monitor MN, video data supplied from the selector 3 and image data output from the system control unit 5 via the data bus 12. It is to be appreciated that it is arbitrary whether to provide a decoder to this video processing unit 3 and it is not always necessary to provide the decoder to this video processing unit 3 if the monitor MN is provided with a decoder.

The sound processing unit 4 has a digital signal processor (DSP), to perform various kinds of signal processing for audio data supplied from the selector 3 under the control of the system control unit 5 and output it to the D/A conversion unit 10. Specifically, the sound processing unit 4 performs each individual signal processing for each channel of audio data, thereby changing characteristics such as a sound pressure of sound output from each of the speakers and timing at which the sound is produced by each of the speakers. For example, in a case where 5.1 channels of audio data is supplied as in the present embodiment, the sound processing unit 4 performs such signal processing as to change the characteristics such as the output timing and the sound pressure for each of the 5.1 channels. It is to be appreciated that a specific processing method in the DSP is the same as the conventional one so that its detailed description is not repeated here. Further, the LFE channel for the subwoofer SW has no orientation, so the following description is made on the assumption that the sound processing unit 4 will perform no signal processing for audio data for this channel in the present embodiment.

The D/A conversion unit 10 performs D/A conversion for the audio data that corresponds to each channel and has been subjected to the signal processing by the sound processing unit 4 and outputs it to the amplification unit 11. It is to be appreciated that, hereinafter, data that is output from the medium playback apparatus MP and not yet to be subjected to D/A conversion is referred to as audio data and a signal obtained by performing D/A conversion for this audio data is referred to as an audio signal.

The amplification unit 11 amplifies the audio signal supplied from the D/A conversion unit 10 and outputs it to the speaker S. This amplification unit 11 has low-frequency amplifiers and output terminals that each correspond to the number of channels available for output and outputs an audio signal that is supplied from the D/A conversion unit 10 in such a manner as to correspond to each channel, to each of the speakers S connected to the output terminal. As a result, an audio signal obtained by performing D/A conversion for audio data in such a manner as to correspond to each channel is output separately from each other through each of the speakers S.

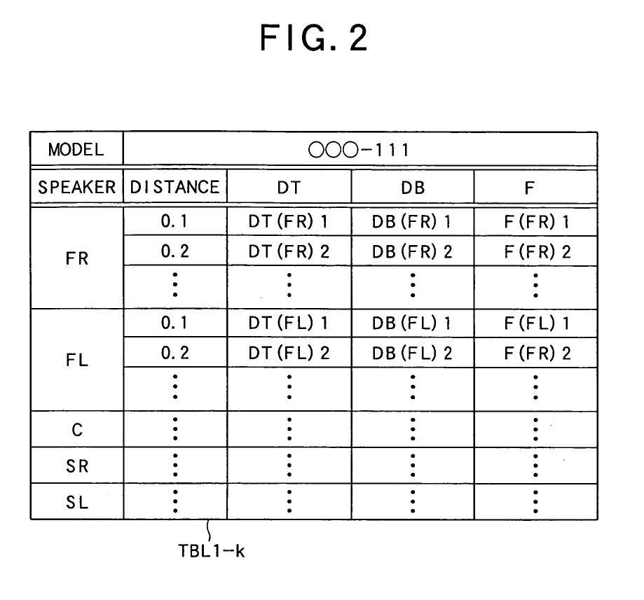

The recording unit 6 is constituted of a nonvolatile memory such as an EEPROM and stores various kinds of information necessary for the sound reproduction apparatus A to perform various processings as well as a plurality of parameter tables TBL1-k (k=1, 2, . . . , n) shown in FIG. 2.

In FIG. 2, “DT”, “DB”, and “F” respectively represent a delay time parameter for altering timing at which to produce sound from the speaker S, a level parameter for altering a sound pressure level, and a frequency characteristic parameter for altering a frequency characteristic. Those parameters are stored in the table TBL1-k as correlated with a distance between a listening point and the speaker S in layout; specifically, such values as to be necessary to recreate an optimal sound field at this distance are calculated and stored beforehand.

It is to be appreciated that a different model of the speaker S has a different characteristic such as a frequency that can be output. Therefore, it is preferable to alter the parameters used when the sound processing unit 4 performs various processings for audio data, in accordance with the model of the speaker S. For this purpose, in the present embodiment, the parameter table TBL1-k is provided for each model of the speaker S, so that each parameter table TBL1-k stores names of the speaker models that correspond to this table TBL1-k.

It is to be appreciated that it is arbitrary whether to store the parameters such as “DT” that correspond to all the channels in each parameter table TBL1-k. For example, some models of the speakers S are dedicated for use as a center speaker or a surround speaker and even a front-dedicated speaker. Such a parameter table TBL1-k as to correspond to a model of the speaker dedicated for use in a specific channel need not store the parameters that correspond to all of the channels but may store only the parameters that correspond to the necessary channels.

Subsequently, the system control unit 5 has, for example, a read only memory (ROM), a random access memory (RAM), and a central processing unit (CPU) and executes a control program stored in the ROM, to control the respective units of the sound reproduction apparatus A.

This system control unit 5 performs the following processings.

(a) Initial Setting Processing

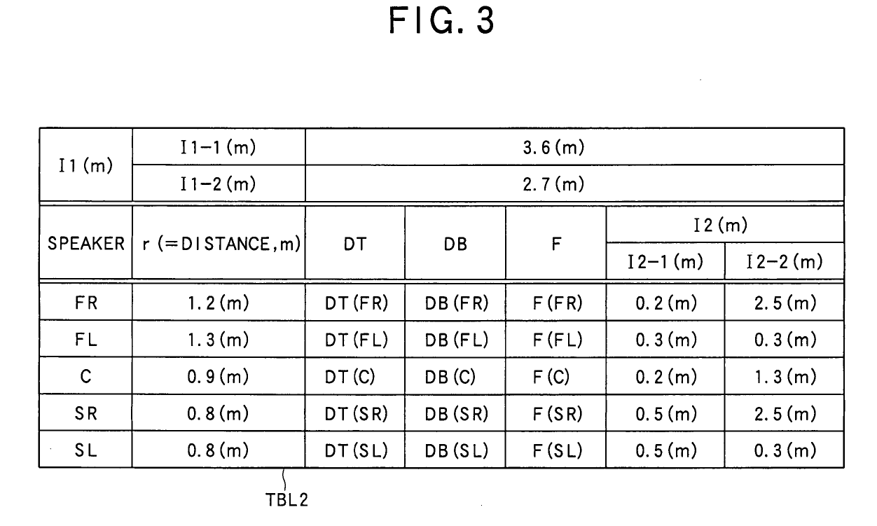

This processing is performed by the system control unit 5 when power is applied in a state where the sound processing apparatus A is not yet to be initialized, for example, in a state where its power is not yet to be applied. In this processing, the system control unit 5 sets a size of a room where the sound reproduction apparatus A is placed, a layout and models of the speakers in the room, and a location of a listening point, generates a setting state table TBL2 (see FIG. 3) in which these information are stored, and records it in the recording unit 6. Further, when generating such a table TBL2, the system control unit 5 extracts from the parameter table TBL1-k the three parameters of “DT”, “DB”, and “F” that are appropriate to recreate an optimal sound field at this listening point and stores these parameters in the setting state table TBL2.

In such a manner, the parameters such as “DT” stored in the generated setting state table TBL2 are utilized by the sound processing unit 4 when it performs signal processing for audio data that corresponds to each channel. Further, in this initial setting processing, the system control unit 5 generates setting screen data based on the generated setting state table TBL2 and records it in the recording unit 6. This setting screen data is used to display a sound field space, that is, a virtual space that recreates a space (the room) where a listener listens to sound produced by the speaker S, in which space locations where the listening point and the speaker S are recreated virtually. The setting state table TBL2 and the setting screen data are described in detail later.

(b) Settings Alteration Processing

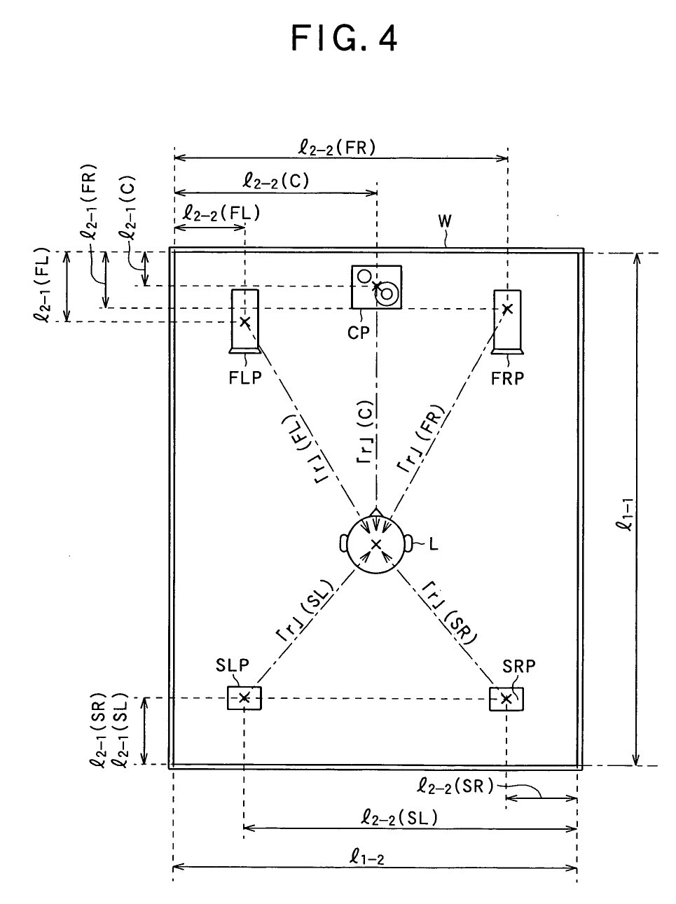

This processing is performed by the system control unit 5 when it alters a set state of the sound reproduction apparatus A. (1) When the location where the speaker S is arranged is altered, (2) if the listening point is altered, it is necessary to alter the parameters such as “DT”. Further, (3) if the user has altered the model of a speaker to be used, the above parameters need to be altered. To accommodate such a change in state, when a predetermined input operation is performed to the instruction input unit 8 or the remote control apparatus, the system control unit 5 reads setting screen data recorded in the recording unit 6 and supplies image data containing this setting screen data to the video processing unit 9, to cause the monitor MN to display such a setting screen as shown in FIG. 4.

When the input operation is performed by the user in accordance with the setting screen displayed on the monitor MN, an altered state in an actual sound field space is calculated on the basis of an altered state in this setting screen, to update the setting state table TBL2. As a result, the parameters to be used when the sound processing unit 4 performs signal processing for audio data that corresponds to each of the channels are altered, to recreate a sound field optimal for the listening point in terms of a positional relationship after this alteration of the location.

In such a manner, in the present embodiment, the setting screen data and the setting state table TBL2 are linked to each other to reflect altered contents of the setting screen data on the setting state table TBL2 so that the setting state table TBL2 may be updated by altering the setting screen data, thereby enabling easily altering the parameters to be used when the sound processing unit 4 performs the signal processing.

(2) About Setting State Table TBL2

The following will describe in detail the setting state table TBL2 which is used to perform the above processing.

First, as shown in FIG. 3, in the present embodiment, the setting state table TBL2 is provided with a field that is used to store parameters “l1-1” and “l1-2” that indicate a size of the room where the sound reproduction apparatus A is placed (hereinafter referred to as “l1” if these need not be identified from each other in particular) and also to store parameters “l2-1” and “l2-2” that indicate locations where the speakers S are arranged (hereinafter referred to as “l2” if these need not be identified from each other in particular). Concerning these parameters “l2-1” and “l2-2”, which each indicate a distance from a center of each speaker S to a wall of the room, the parameter “l2-1” indicates a distance in the rear of the speaker S (distance to the wall in the rear of the speaker as viewed from the listener) and the parameter “l2-2” indicates a left-side distance as viewed from a front of the speaker (distance to the wall in the left direction of the speaker as viewed from the listener).

It is to be appreciated that it is arbitrary what method is to be used for setting parameters “l1” and “l2” when initially setting the sound reproduction apparatus A. For example, such a configuration may be given that the user can register them arbitrarily. Further, such a value of parameter “l2” as to be in accordance with ITU-R International Telecommunications Union-Radiocommunication Sector) BS (Broadcasting service) 775-1 may be calculated and used based on the size of room.

Further, in this setting state table TBL2, the above three parameters “DT”, “DB”, and “F” are stored as correlated with parameter “r” that indicates a distance from the speaker s corresponding to each channel to the listening point. Those thee parameters “DT”, “DB”, and “F” are extracted from the parameter table TBL1-k that corresponds to the model of the speaker S currently used and stored, thus providing parameter “DT” etc. stored as correlated with a distance corresponding to parameter “r” in this parameter table TBL1-k.

To perform signal processing for audio data that corresponds to each channel in the sound processing unit 4, parameter “DT” etc. stored in this setting state table TBL2 is utilized. As a result, an optimal sound field is recreated at the listening point. It is to be appreciated that it is arbitrary what method is to be used to set parameter “r” in initial setting, for example such a configuration may be given that the user registers it arbitrarily. However, to make description more specific, the description is made on the assumption that “r” is set automatically in the present embodiment. Specifically, in the present embodiment, the sound processing unit 4 outputs an impulse signal for each channel under the control of the system control unit 5 in condition where a microphone is connected. Based on sound collected by the microphone, the delay time parameter “DT”, the level parameter “DB”, and the frequency characteristic parameter “F” are calculated. The system control unit 5 reads a distance stored in the parameter table TBL1-k as correlated with a parameter that agrees with those parameters calculated by this sound processing unit, thereby calculating the distance between the listening point and each speaker S.

(3) About Setting Screen Data

Next, setting screen data is described in detail. First, as shown in the above FIG. 4, a frame W is drawn on the setting screen displayed on the monitor MN based on the setting screen data. This frame W indicates an internal space of the room in which the sound reproduction apparatus A is placed and has a value that corresponds to parameter “l1” stored in the setting state table TBL2. When drawing this frame W, the system control unit 5 decides a size of the frame W and sets coordinates in the frame W, based on a value of parameter “l1” and the number of pixels of the monitor MN that can be displayed. It is to be appreciated that an arbitrary method may be used for the system control unit 5 to set a size and coordinates of the frame W. However, in the present embodiment, the system control unit 5 makes settings by using the following method. That is, the system control unit 5 decides the number of pixels for, for example, “0.1 m” (unit length) from the number of pixels of the monitor MN that can be displayed and parameter “l1”. For example, in case of “l1-1”=“3.6 m” and “l1-2”=“2.7 m” when the number of pixels of the monitor MN that can be displayed is horizontal “1024” pixels X, vertical “768” pixels, a maximum number of pixels that can be set for each “0.1 m” is “21”.

In this case, to display the entire frame W on the monitor MN as displaying a predetermined blank portion for a drawing range of the frame W, it is preferable to set “15” or such number of pixels for each unit length. Therefore, the system control unit 5 sets, for example, “15” as the number of pixels for each unit length, to draw the frame W having “540” pixels vertically and “405” pixels horizontally. In such a manner, the drawn frame W is divided by the system control unit 5 into vertical and horizontal unit lengths, and coordinates (X, Y) are set by it to an intersection between axes that divides the frame W by using a left bottom corner of the frame W as point 0. For example, in the above case, the frame W is divided by “27” horizontally and “36” vertically, so that coordinates (0, 0) through (27, 36) are set.

Further, in this frame W, icons FRP, FLP, CP, SRP, and SLP (hereinafter referred to as “icons P” generically if they need not be identified from each other) that indicate arranged locations of the speakers S, and an icon L that indicates the listening point are drawn. Those icons P are drawn at a location that corresponds to parameter “l2” in the setting state table TBL2. For example, in case of “l2-1”=“0.3 m” and “l2-2”=“0.3 m” for the speaker FRS of the “FR” channel, the system control unit 5 plots the icons at coordinates that correspond to position “0.3 m” from a left frame in the frame W and position “0.3 m” from a top frame in it, that is, a location (3, 3), to draw the icons P using this plot as a center.

Further, the icon L is drawn on the basis of a location where the above speaker position P is plotted and the parameter “r” stored in the setting state table TBL2. Specifically, such a concentric circle is assumed as to have a radius “r” in a condition where coordinates of a plot that corresponds to the location where each speaker S is arranged as its center. For example, in the case of an example of the setting state table TBL2 shown in FIG. 3, a parameter of “r=1.0 m” is stored in a field that corresponds to the “FR” channel. In this case, a concentric circle having a radius “1.0 m” is set in a condition where the above coordinates (3, 3) is set as a center.

With this, the system control unit 5 plots the icons at coordinates that are closest to a position where all the circles that are set for the speakers S intersect with each other, to draw the icon L using these coordinates as a center. Further, those circles are not in some cases intersect with each other accurately at one point, in which case an arbitrary point may be set by the system control unit 5 as the listening point. For example, a plurality of points where the circles intersect with each other may be recognized as a correction value so that the icons would be plotted at a predetermined location or the icons may be plotted at a center point of the plurality of points where the circles intersect with each other. Anyhow, in such a case, that non-coincidence can be processed as an error to prevent erroneous processing.

It is to be appreciated that since coordinates are set in this setting screen as described above, when the icons P and L are moved, a new distance between the speaker S and the listening point in the sound field space can be calculated on the basis of coordinates before and after the movements of these icons P and L. The system control unit 5 updates the parameter “r” in the setting state table TBL2 based on these calculation results. The system control unit 5 then searches the parameter table TBL1-k by using this updated “r” as a retrieval key, to read parameters such as “DT” stored in the parameter table TBL1-k as correlated with a distance that corresponds to this “r” and, based on this read parameters, updates parameters such as “DT” stored in the setting state table TBL2.

### [1.2] Operations of the Present Embodiment

(1) Operations at the Time of Initial Setting

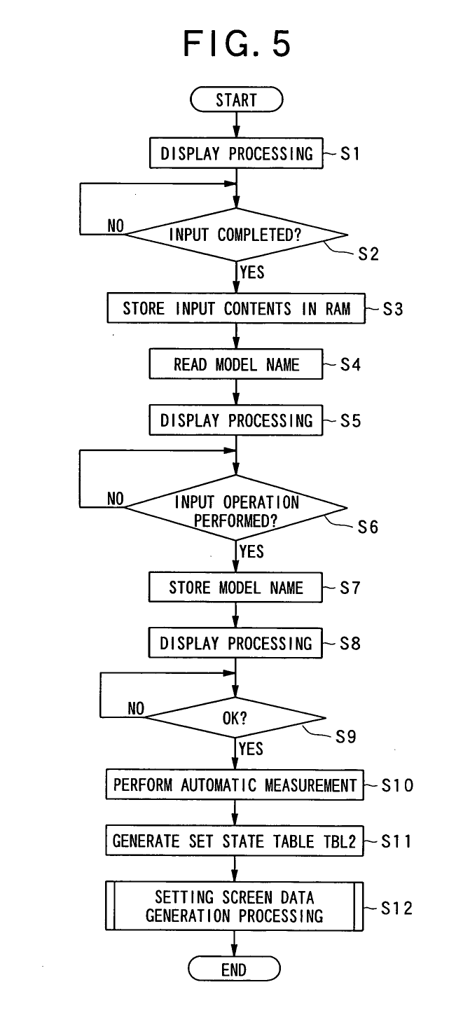

Next, operations at the time of initial setting in the sound reproduction system SY according to the present embodiment are described with reference to FIG. 5. To perform initial setting, first the user needs to arrange the speakers S that correspond to the channels, turn on power of the sound reproduction apparatus A, and perform predetermined input operations to the remote control apparatus and the instruction input unit 8. It is to be appreciated that arbitrary contents can be supplied by these input operations. or example, a dedicated key for initial setting may be provided to the instruction input unit 8 and the remote control apparatus.

The system control unit 5 is triggered by such input operations, to perform such initial setting processing as shown in FIG. 5. In this processing, the system control unit 5 first generates image data and supplies it to the video processing unit 9 (step S1), to provide a state for waiting for input by the user (“NO” at step S2).

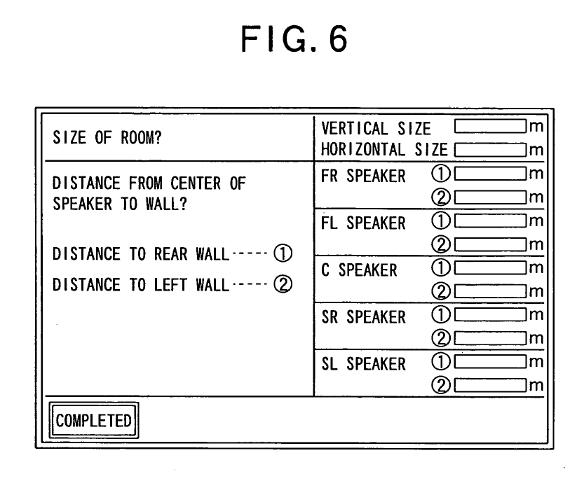

If the above display processing is performed, on the other hand, the monitor MN prompts inputting of parameters “l1” and “l2” as shown, for example, in FIG. 6 and displays a box for supplying these parameters and a button “COMPLETED”. In this state, the user needs to measure the size of the room and a distance between the center of the speaker S and the rear wall, and a distance between that center and the left wall in front of the speaker and supply these measurement results to the instruction input unit 8 etc. When all the parameters are supplied completely and the user performs an input operation, to the instruction input unit 8 etc., of the effect that he would select the COMPLETED button, the system control unit 5 determines “YES” at step S2, to store these input contents in an RAM, not shown (step S3).

Subsequently, the system control unit 5 reads a model name of the speaker S stored in the parameter table TBL1-k (step S4), generates image data that corresponds to a list for selection of this read model name, supplies it to the video processing unit 9 (step S5), and then enters a state for waiting for an input operation by the user (“NO” at step S6). As a result, the monitor MN displays a list of the model names of the selectable speakers S. In this state, the user performs an input operation, to the instruction input unit 8 or the remote control apparatus, of the effect that he would select a model name. Then, the system control unit 5 determines “YES” at step S6, stores this selected model name in the RAM (step S7), generates image data again, outputs it to the video processing unit 9 (step S8), and enters a state for waiting for an input operation by the user (“NO” at step S9).

As a result, the monitor MN displays a character string such as “A location of a listening point L is detected automatically. When you are ready, please select a START button” and the “START” button”. In this state, when the user moves the microphone to a location of the listening point and performs an input operation, to the instruction input unit 8 etc., of the effect that he would select the “START” button, the system control unit 5 determines “YES” at step S9 and outputs a control signal to the sound processing unit 4 (step S10). As a result, the sound processing unit 5 outputs audio data that corresponds to the impulse signal to the D/A conversion unit 10 and calculates the parameters “DT”, “DB”, and “F” in accordance with sound collected through the microphone.

When these parameters are calculated in such a manner, the system control unit 5 searches the parameter table TBL1-k that corresponds to a model name stored in the RAM, to read a distance stored as correlated with such parameters as this calculated “DT”. Then, the system control unit 5 generates the setting state table TBL2 based on this distance, the model name stored in the RAM, and parameters “l1” and “l2” (step S11).

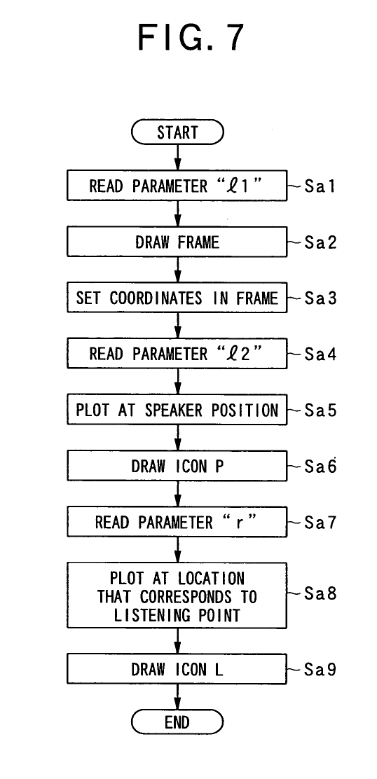

When the setting state table TBL2 is generated as a result of the above processing, the system control unit 5 generates setting screen data shown in FIG. 7 based on the generated setting state table TBL2 (step S12) and ends the initial setting processing.

In this setting screen data generation processing (step S12), the system control unit 5 first reads parameters “l1-1” and “l1-2” relating to the size of the room from the generated setting state table TBL2 (step Sa1) and, based on these parameters “l1-1” and “l1-2”, draws the frame W in the RAM (STEP Sa2). In this case, the system control unit 5 calculates the number of pixels per unit length (e.g., 10 cm) based on the parameters “l1-1” and “l1-2” and the number of pixels of the monitor MN that can be displayed, to draw the frame W that corresponds to this number of pixels.

Subsequently, the system control unit 5 sets a coordinate axis in this drawn frame W (step Sa3) and then reads parameters “l2-1” and “l2-2” relating to the arranged location of the speaker S that corresponds to each channel from the setting state table TBL2 (step Sa4) and, based on these parameters “l2-1” and “l2-2”, plots the icons in the frame W (step Sa5). In this case, for example, in case of “l2-1”=“0.3 m” and “l2-2”=“0.3 m” for the speaker FRS for the “FR” channel, the system control unit 5 plots the icons at a location of coordinates (3, 3).

When they are plotted in such a manner, the system control unit 5 draws an image that corresponds to the icon P on this plot (step Sa6) and reads the parameter “r” from the setting state table TBL2 (step Sa7). Then, the system control unit 5 plots the icons at a location that corresponds to the listening point based on these parameters (step Sa8), draws an image that corresponds to the icon L (step Sa9), and ends the processing.

As a result of performance of the above series of processings, such setting state table TBL2 and setting screen data as to correspond to the initial setting are recorded in the recording unit 6 in the sound reproduction apparatus A.

(2) Operations at the Time of Altering Settings

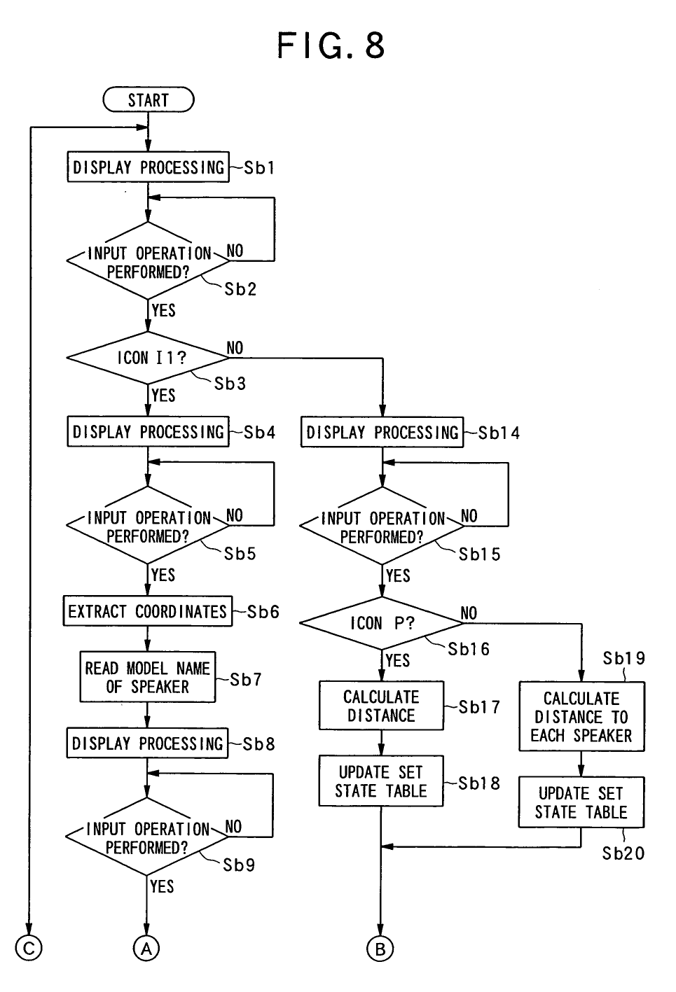

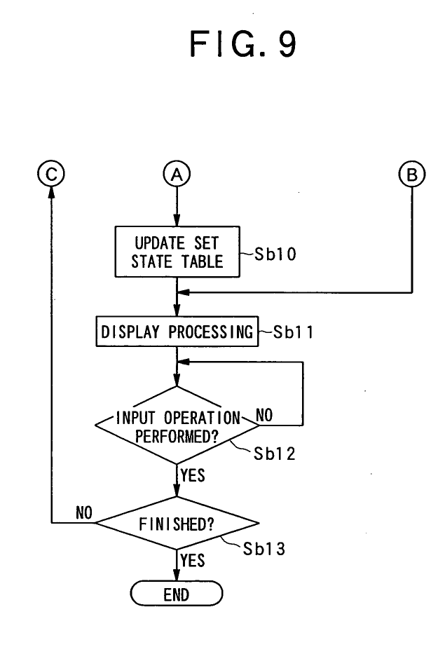

Next, operations at the time of altering settings in the sound reproduction apparatus A according to the present embodiment are described with reference to FIGS. 8 and 9. To alter settings of the sound reproduction apparatus A, the user first needs to perform a predetermined input operation to the instruction input unit 8 or to the remote control apparatus not shown. It is to be appreciated that contents of this input operation are arbitrary.

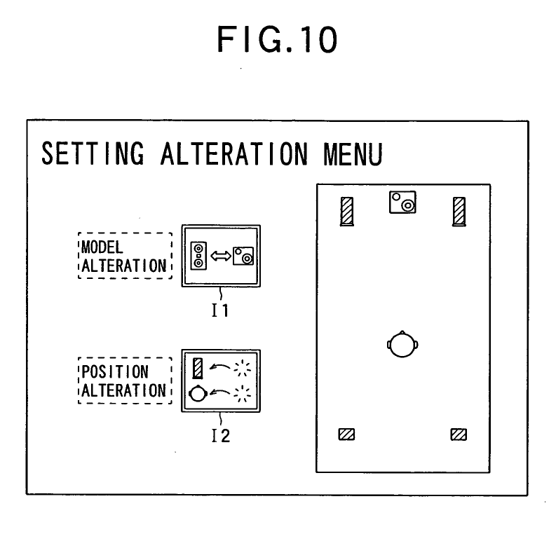

When such an input operation is performed, the system control unit 5 starts setting alteration processing shown in FIGS. 8 and 9. In this setting alteration processing, the system control unit 5 first reads setting screen data from the recording unit 6, generates image data that draws this setting screen data, supplies this image data to the video processing unit 9 (step Sb1), and enters a state for waiting for selection by the user (“NO” at step Sb2). As a result, the monitor MN displays such an image as shown in, for example, FIG. 10.

As shown in the figure, in this case, such an image that corresponds to the setting screen is displayed on the monitor MN, for example, together with icons I1 and I2 that are used to select contents of settings to be altered. It is to be appreciated that those icons I1 and I2 correspond to a command for altering the model of the speaker S and a command for altering the locations of the speaker S and the listening point, respectively. Therefore, on this screen, if one of these icons I1 and I2 is selected, the processing for the icons 11 and l2 is performed by the system control unit 5.

In this state, if the user performs an input operation, to the instruction input unit 8 or to the remote control apparatus, of the effect that he would select the icon I1 or I2, the system control unit 5 determines “YES” at step Sb2 and enters a state for deciding which one of the icons I1 and I2 has been selected (step Sb3). If the user has performed such an input operation as to select the icon I1, the system control unit 5 comes up with “YES” as a result of this decision, generates setting screen data and image data that draws a character string saying, for example, “Please select the speaker S whose model is to be altered”, supplies them to the video processing unit 9 (step Sb4), and enters a state for waiting for input by the user (“NO” at step Sb5). In this state, the user needs to perform an input operation for selecting the speaker S whose model is to be altered.

When the user performs an input operation of the effect that he would select the speaker S whose model is to be altered, the system control unit 5 determines “YES” at step Sb5, extracts coordinates of this selected speaker S, and stores the coordinates in the RAM (step Sb6). Subsequently, the system control unit 5 reads a model name of the speaker from the parameter table TBL1-k recorded in the recording unit 6 (step Sb7) and, based on this read model name, generates image data that corresponds to a list for selection of the speaker models, supplies it to the video processing unit 9 (step Sb8), and enters a state for waiting for an input operation by the user (“NO” at step Sb9).

As a result of such processing, the list of the model names of the speakers S that can be selected is displayed on the monitor MN. In this state, the user operates the instruction input unit 8 or the remote control apparatus, to thereby perform an input operation of the effect that he would select the model name. Then, the system control unit 5 determines “YES” at step Sb9, to update the setting state table TBL2 (step Sb10). In this case, the system control unit 5 reads the parameter “r” that corresponds to each channel from the setting state table TBL2, to read the parameters “DT”, “DB”, and “F” stored in the parameter table TBL1-k as correlated with a distance that corresponds to this “r”. The system control unit 5 then stores these parameters such as “DT” in a field that corresponds to this “r” in the setting state table TBL2, thereby updating the setting state table TBL2 (step Sb10).

Subsequently, the system control unit 5 generates image data and supplies it to the video processing unit 9 (step Sb11) and enters a state for waiting for input by the user (“NO” at step Sbl2). As a result, the monitor MN displays a character string saying, for example, “The settings are altered; continue to alter the settings ?” together with two buttons of “CONTINUE” and “END”. In this state, if the user performs an input operation, to the instruction input unit 8 or the remote control apparatus, of the effect that he would select either one of the buttons, the system control unit 5 determines “YES” at step Sbl2 and determines whether this selected button is the “END” button (step Sbl3). If this decision comes up with “YES”, the system control unit 5 ends the processing.

On the other hand, if this decision comes up with “NO”, that is, if the user has performed an input operation of the effect that he would select the “CONTINUE” button, the system control unit 5 performs steps Sb1 and Sb2 again. As a result, such an image as shown in the above-described FIG. 10 is displayed on the monitor MN. When the user performs an input operation of the effect that he would select the icon 12, the system control unit 5 generates data that corresponds to a character string saying, for example, “Please select a movement target on the setting screen and drag and drop it” and image data containing the setting screen data, supplies them to the video processing unit 9 (step Sb14), and enters a state for waiting for an input operation by the user (“NO” at step Sb15).

In this state, the system control unit 5 monitors an input to the instruction input unit 8 etc., to calculate how much the coordinates of the icon being dragged are changed horizontally and vertically from a location before being moved. From the horizontal and vertical changes in coordinates of this icon, the system control unit 5 causes the monitor MN to display vertical and horizontal movement distances of this icon in a listening space.

While on the other hand, in accordance with the image displayed on the monitor MN, the user performs an input operation, to the instruction input unit 8 etc., of the effect that he would drop the icon which he selects. Then, the system control unit 5 determines “YES” at step Sb15 and enters a state for deciding what has been moved corresponds to the icon P (step Sb16).

If, for example, the user has selected the icon FLP that corresponds to the speaker S of the “FL” channel and has performed an input operation, to the instruction input unit 8, of the effect that he would decide a movement destination, the system control unit 5 determines “YES” at step Sb16 and calculates a distance to the listening point from coordinates of the movement destination of the speaker S that corresponds to the “FL” channel on the setting screen (step Sb17). It is to be appreciated that an arbitrary method may be used to calculate the distance. For example, the following method can be employed. That is, if the coordinates that correspond to the movement destination are (X′, Y′) and those of the listening point are (X1, Y1), the distance between the movement destination of the speaker S and the listening point is calculated by calculating the following equation:
R=\sqrt{(X′−X1)²+(Y′−Y1)²} Equation (1)
where R is a distance from the movement destination of the speaker S top the listening point.

When the calculation of the distance is completed in such a manner, the system control unit 5 updates the setting screen data and the setting state table TBL2 based on this calculation result (step Sb18). In this case, the system control unit 5 reads a model name stored in the setting state table TBL2, sets the parameter table TBL1-k, correlates it with this calculated distance, and reads the parameter such as “DT” stored in this parameter table TBL2. The system control unit 5 overwrites the parameters stored in the setting state table TBL2 by using the read parameters such as “DT”, to update the setting state table TBL2 (step Sb18). Further, in this case, the system control unit 5 plots also the setting screen data at coordinates that correspond to the movement destination location, alters a drawing location of the icon P or L, and records this altered setting screen data in the recording unit 6 (step Sb18).

If the user has selected the icon L that corresponds to the listening point and has performed an input operation of the effect that he would decide a movement destination location, on the other hand, the system control unit 5 determines “NO” at step Sb16 and calculates a distance from this movement destination to each speaker S (step Sb19). It is to be appreciated that in this case, an arbitrary distance calculation method may be selected as in the case of the above. In such a manner, when the distance between the listening point and the speaker S is calculated, the system control unit 5 updates the setting state table TBL2 and the setting screen data based on this calculation result (step Sb20).

When such processing is completed, the system control unit 5 performs processing of steps Sb11 through Sb13 again and, if the “END” button is selected, determines “YES” at step Sb13 and, if the “CONTINUE” button is selected, repeats processing of steps Sb1 through Sb20.

When the setting state table TBL1 is altered through the above processing, the sound processing unit 4 performs signal processing for input audio data based on this updated setting state table TBL2. Specifically, based on the parameter “DT” stored in this updated setting state table TBL2, it alters delay time of the audio data that corresponds to each channel or alters a sound pressure of the audio data based on the parameter “DB” and, further, alters a frequency characteristic.

As described above, the sound reproduction apparatus A according to the present embodiment for causing each speaker that corresponds to each of a plurality of audio signals based on these audio signals such as audio data that corresponds to a plurality of channels to loud-speak sound so that a sound field space having a sense of reality may be provided to a listener, comprises in configuration the video processing unit 9 and the system control unit 5 for causing the monitor MN to display a setting screen which is a screen for displaying a virtual space that recreates the sound field space and on which the icons P and L are drawn at locations that respectively correspond to the listening point (location where the listener listens to) and a location of each speaker S in the sound field space and for altering this setting screen in accordance with an input operation performed by the user based on this setting screen, the system control unit 5 for providing a set state of each speaker S and a set state of the listening point in the virtual space based on the setting screen to recognize, for example, a moved state of the locations where the listening point and the speaker S are arranged and, based on a result of this recognition, calculating an actual distance between each speaker S and the listening point in the sound field space, and the sound processing unit 4 and the system control unit 5 for performing signal processing in accordance with the calculated distance for the audio signal.

By this configuration, if the setting screen is altered by an input operation of the user, as set states of each speakers and the listening point, for example, those moved states are recognized by the system control unit 5 based on the altered setting screen, so that the post-movement distance is calculated by the system control unit 5. As a result, the audio data is subjected to signal processing by the sound processing unit 4 for each channel by utilizing a parameter that corresponds to this calculated distance. Therefore, even if the location of the listening point or the location where the speaker S is arranged is altered, it is possible to easily create an optimal sound field without performing automatic measurement again or measuring a distance between the speaker and the wall by using a measuring tape.

Further, the present embodiment has employed such a configuration that when having recognized movement of the listening point or each speaker S in the virtual space, the system control unit 5 in the sound reproduction apparatus A may calculate an actual distance between each speaker S and the listening point in the sound field space based on a result of this recognition. By this configuration, alteration in location of the listening point etc., on the setting screen is recognized as required, to calculate the post-movement distance. Therefore, it is possible to appropriately alter the parameter used when performing signal processing for the audio data in accordance with the post-movement distance without performing complicated tasks, thereby creating an optimal sound field at the listening point even after the speaker S etc., is moved.

Further, the present embodiment has employed such a configuration that the system control unit 5 in the sound reproduction apparatus A may define a point of coordinates on the setting screen, to recognize movement destinations of the speaker S and the listening point in the virtual space based on drawn coordinates of the icons P and L on this setting screen. Therefore, it is possible to accurately calculate a moving distance before and after the movement of the speaker etc., based on coordinates of each point, thereby creating an optimal sound field at the listening point even after the speaker S etc., is moved.

Furthermore, the sound reproduction apparatus A according to the present embodiment further comprises, in configuration, the recording unit 6 for recording the parameter table TBL1-k in which a parameter (operation coefficient) used when the sound processing unit 4 performs signal processing for audio data that corresponds to each channel is stored as correlated with a distance between the speaker S and the listening point so that the sound processing unit 4 may perform the signal processing by utilizing the parameter stored in the parameter table TBL1-k as correlated with a calculated distance. By this configuration, the signal processing based on the parameter stored in the parameter table TBL1-k is performed, so that even if the speaker S etc., is moved, it is possible to recreate an optimal sound field at the listening point.

Furthermore, the sound processing unit 4 in the sound reproduction apparatus A according to the present embodiment has such a configuration as to perform signal processing that alters a delay time, a sound pressure level, and a frequency characteristic of audio data that corresponds to each channel, based on a calculated distance. Therefore, appropriate signal processing is performed for each channel, to recreate an optimal sound field at the listening point.

Further, in the sound reproduction apparatus A according to the present embodiment, the system control unit 5 has such a configuration as to draw the icon L that indicates a location that corresponds to the listening point in a sound field space and also to draw the icon P that indicates a speaker at a location that corresponds to a place where each speaker S is arranged. Therefore, the listener who has viewed the setting screen can determine the current set state at a glance, to make settings.

Although the present embodiment has been described in a case where the sound reproduction apparatus A receives 5.1 channels of audio data, any number of channels of audio data may be supplied.

Although the present embodiment has employed such a configuration that the five speakers of FRS, FLS, CS, SRS, and SLS are connected to the sound reproduction apparatus A to output different channels of audio signals, six or more speakers may be connected.

Furthermore, the sound reproduction apparatus A according to the present embodiment has such a configuration as to utilize the parameter “r” stored already in the setting state table TBL2, that is, a distance between the listening point and the speaker S when altering the model of the speaker S. However, such a configuration may be employed that the distance may be calculated newly when altering the model of the speaker S.

Furthermore, the recording unit 6 in the sound reproduction apparatus A in the above embodiment has such a configuration as to record beforehand the parameter table TBL1-k that corresponds to each model. However, such parameter table TBL1-k may be of such a configuration as to be downloaded via a network such as the Internet. In this case, it is necessary to provide the sound reproduction apparatus A with a World Wide Web (WWW) browser and a network interface. Alternatively, the Internet may as well be provided with a file transfer protocol (FTP) server that holds the parameter table TBL1-k as a resource so that the parameter table TBL1-k may be downloaded from this server as necessary.

Furthermore, the sound reproduction apparatus A in the present embodiment has such a configuration that if the position of the speaker S is altered on the setting screen, the system control unit 5 may update contents of the set state table TBL2 and the sound processing unit may process audio data by utilizing various parameters stored in this updated set state table TBL2 to realize normal positioning of a sound image with respect to the listening point. However, it may be also possible to add a new speaker S or delete an already arranged speaker by operations on the setting screen, in addition to altering of position.

To employ this configuration, it is necessary to employ the following method. That is, if the speaker S already arranged on the setting screen is deleted, the system control unit 5 deletes the parameters stored in a field that corresponds to this deleted speaker S in the set state table TBL-2 and also reads from the parameter table TBL1-k the parameters such as “DT” that correspond to the number of the speakers after this deletion, to update the set state table TBL1-k by using these parameters. The sound processing unit 4 superimposes audio data of a channel that corresponds to this deleted speaker S onto audio data of the other channels and computes and processes this superimposed audio data by utilizing the parameters stored in the updated set state table TBL2. Then, the sound processing unit 4 outputs this processed audio data to the D/A conversion unit 10, to turn OFF outputting of the audio signal to this deleted speaker S.

When a new speaker S is added on the setting screen, on the other hand, the system control unit 5 creates a field that corresponds to this added speaker S in the set state table TBL2, to additionally write various kinds of parameters in this field. Then, the sound processing unit 4 processes and computes audio data based on this updated set state table TBL2.

Furthermore, the present embodiment has employed such a configuration that the user may enter a size of a room in which the sound reproduction system SY is placed, in accordance with an image displayed on the monitor MN. However, in measurement of the size of the room, each speaker S may loud-speak sound so that this sound would be collected by a microphone to measure the size of the room automatically.

Furthermore, the present embodiment has employed such a configuration that digital audio data and video data may be supplied to the sound reproduction apparatus from the medium playback apparatus MP. However, contents data read from a medium may be converted into an analog signal by the medium reproduction apparatus MP and supplied to the sound reproduction apparatus A. In this case, it is not necessary to provide a decoder to the video processing unit 9 nor necessary to provide the D/A conversion unit 8.

### [2] Variants of the Present Embodiment

(1) Variant 1

The sound reproduction system SY according to the above embodiment has employed such a configuration that the parameter table TBL1-k may be provided for each speaker model so that the parameter table TBL1-k to be used would be changed in accordance with the model of a speaker to be used. However, this parameter table TBL1-k need not always be provided for each model of the speaker S; for example, it may be provided for each speaker size such as “LARGE”, “SMALL”, etc. In particular, since a frequency characteristic of sound which is loud-spoken by the speaker S depends on the speaker size significantly, by providing the parameter table TBL1-k in accordance with the speaker size, it is possible to alter the parameter used to perform signal processing in accordance with the model of the speaker S. Further, if such a method is employed, the parameters such as “DT” etc., that correspond to the speaker S having each size may as well be stored in one table TBL1-k without providing a plurality of parameter table TBL1-k.

Furthermore, the model name of the speaker S may be stored in the parameter table TBL1-k as correlated with the size so that a screen for selecting the speaker S to be used based on the model name may be displayed on the monitor MN, to decide the size of a speaker to be used actually based on an input operation performed by the user in accordance with this screen.

Furthermore, in a case where the parameter need not be changed in accordance with the model of the speaker S, the parameters such as “DT” in accordance with each distance may be stored in one parameter table TBL1-k and utilized, to create and update the set state table TBL2.

(2) Variant 2

In the sound reproduction system SY according to the above embodiment, the sound reproduction apparatus A has been constituted of one apparatus such as an AV amplifier. However, in the present variant, for example, the AV amplifier and an information processing apparatus such as a personal computer are connected to each other so that the computer may perform the processing that has been performed by the sound reproduction apparatus A alone in the above embodiment.

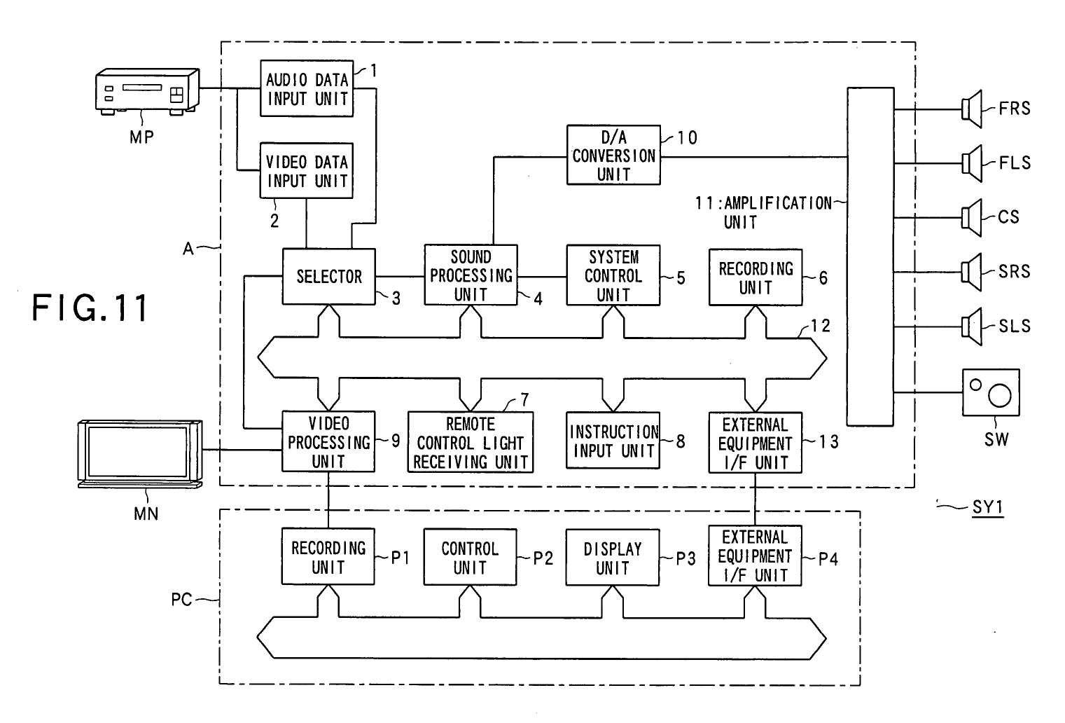

A configuration of a sound reproduction system SY1 according to the present variant that realizes such function is shown in FIG. 11. It is to be appreciated that in the figure the same components as those shown in FIG. 1 are indicated by the same reference symbols. Therefore, the component indicated by the same reference symbol has the same configuration as that of the above embodiment and performs the same operations unless otherwise specified. As shown in the figure, the sound reproduction system SY according to the present variant comprises a monitor MN, a medium playback apparatus MP such as a DVD recorder, a front right speaker FRS that provides a sound source, a front left speaker FLS, a center speaker CS, a surround right speaker SRS, a surround left speaker SLS, a sound reproduction apparatus A1, and an information processing apparatus PC.

It is to be appreciated that in the present variant, the sound reproduction apparatus A1 has an external equipment interface unit (hereinafter, “interface” is abbreviated as “I/F”) 13 for arbitrating transfer of data with the information processing apparatus PC, and is connected to the information processing apparatus PC via this external equipment I/F unit 13. The information processing apparatus PC connected to this sound reproduction apparatus A1 has a recording unit P1, a control unit P2, an external equipment I/F unit P3, and a display unit P4, and the recording unit P1 stores the parameter table TBL1-k, the set state table TBL2, and the setting screen data that have been recorded in the recording unit 6 of the sound reproduction apparatus A in the above embodiment.

Further, this recording unit P1 records the above tables and a control program used by the control unit P2 to control components of the information processing apparatus PC, so that the control unit P2 executes this control program to thereby create and update the set state table TBL2 and the setting screen data. It is to be appreciated that operations performed by this control unit P2 to generate the set state table TBL2 and the setting screen data in initial setting of the sound reproduction apparatus A1 are the same as those of the above-described FIGS. 5 and 7, and operations performed to update the set state table TBL2 and the setting screen data are the same as those of the above-described FIGS. 8 and 9, and so their detailed description is not repeated here. It is to be appreciated that when settings are altered, the setting screen is displayed on the display unit P4.

Further, this control unit P2 has a function to transmit the set state table TBL2 via the external equipment I/F unit P3 to the sound reproduction apparatus A1 when this set state table TBL2 is generated and when this set state table TBL2 is updated. The set state table TBL2 transmitted by this information processing apparatus PC is recorded in a recording unit 16 in the sound reproduction apparatus A1, to be utilized when a sound processing unit 4 in the sound reproduction apparatus A1 processes and computes audio data.

Therefore, if contents of the set state table TBL2 are updated in the information processing apparatus PC, this updated set state table TBL2 is always shared in use by the sound reproduction apparatus A1, so that set contents altered by the user are fed back to the sound reproduction apparatus A1, to be utilized in processing etc., of audio data.

As described above, in the sound reproduction system SY1 according to the present variant comprising a plurality of speakers S, the sound reproduction apparatus A1 for causing each of the speakers to loud-speak sound by each of the corresponding plurality of audio signals such as audio data that corresponds to a plurality of channels based on this plurality of audio signals so that a sound field space having a sense of reality may be provided to a listener, and the information processing apparatus PC for performing a variety of kinds of signal processing, the information processing apparatus PC comprises a control unit P2 for causing the display unit P3 to display a setting screen which is a screen to display a virtual space that recreates a sound field space and on which icons P and L are drawn at locations that correspond to locations where a listening point and each speaker S are arranged respectively in this sound field space and also for altering this setting screen in accordance with an input operation performed by the user based on this setting screen and recognizing set states of each speaker and the listening point in the virtual space based on the setting screen while calculating an actual distance between each speaker S and the listening point in the sound field space based on a result of this recognition so that the sound reproduction apparatus A1 may be controlled on the basis of a result of this calculation, and the sound reproduction apparatus A1 comprises the sound processing unit 4 for performing signal processing that corresponds to the calculated distance for audio data that corresponds to each channel under the control of the information processing apparatus PC.

By this configuration, if the setting screen is altered in accordance with an input operation performed by the user, as a set state of each speaker S or the listening point, for example, a moved state of them is recognized by the control unit P2 in the information processing apparatus PC based on this altered setting screen, so that the post-movement distance is calculated by the control unit P2. As a result, audio data is subjected by the sound processing unit 4 in the sound reproduction apparatus A1 to signal processing for each channel by utilizing a parameter that corresponds to this calculated distance. Therefore, even if a location of the listening point or a location where the speaker S is arranged is altered, it is possible to easily recreate an optimal sound field without performing automatic measurement again or measuring the distance between the speaker and the wall by using a measuring tape.

Although the present variant has employed such a configuration that an actual distance in a sound field space, that is, a distance between the listening point and each speaker S is calculated in accordance with set contents on the setting screen so that control to be conducted when the sound reproduction apparatus A1 performs signal processing for audio data that corresponds to each channel may be performed by the information processing apparatus PC, a recording medium in which a program that regulates operations of this control processing is recorded and a computer for reading it may be provided so that the same recording processing operations as the above would be performed by reading this program by using this computer.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2004-101045 filed on Mar. 30, 2004 including the specification, claims, drawings and abstract is incorporated herein by reference in its entirety.

1. A sound reproduction apparatus for causing each of speakers that corresponds to each of a plurality of audio signals to loud-speak based on the plurality of audio signals, the apparatus comprising:
a display control device that causes a display device to display a setting screen which is a screen to display a virtual space that recreates the sound field space and on which a selected image is drawn at a listening position of the listener and a location that corresponds to a position where each of the speakers is arranged in the sound field space and that alters the setting screen in accordance with an input operation performed by a user based on the setting screen;
a recognition device which recognizes a set state of each of the speakers and a set state of the listening position in the virtual space based on the setting screen;
a calculation device which calculates an actual distance between each of the speakers and the listening position in the sound field space based on a result of the recognition; and
a sound processing device which performs signal processing for the audio signals that corresponds to the calculated distance.

2. The sound reproduction apparatus according to claim 1, wherein the recognition device recognizes at least one of set states of (1) movement of the listening position, (2) movement of the location where each of the speakers is arranged, (3) deletion of the speaker already arranged, (4) addition of a new speaker, (5) alteration of a model of the speaker, and (6) alteration of a size of the speaker, in the virtual space based on the setting screen.

3. The sound reproduction apparatus according to claim 2, wherein if the recognition device has recognized movement of the listening position or movement of the location where each of the speakers is arranged in the virtual space,
the calculation device calculates an actual distance between each of the speakers and the listening position in the sound field space based on a result of the recognition.

4. The sound reproduction apparatus according to claim 2, wherein if the recognition device has recognized deletion of the speaker already arranged in the virtual space, the sound processing device superimposes the audio signal that corresponds to the deleted speaker onto the other audio signal, thus performing the signal processing.

5. The sound reproduction apparatus according to claim 2, wherein if the recognition device has recognized new addition of the speaker into the virtual space:
the calculation device calculates an actual distance between the speaker added in the sound field space and the listening position based on a result of the recognition; and
the sound processing device assigns the added speaker the audio signal to be output and performs the signal processing that corresponds to the calculated distance for this audio signal.

6. The sound reproduction apparatus according to claim 2, wherein:
the display control device defines a point of coordinates in the setting screen; and
the recognition device recognizes a movement destination of the speaker and a movement destination of the listening position in the virtual space based on drawn coordinates of the selected image on the setting screen.

7. The sound reproduction apparatus according to claim 1, further comprising a recording device in which an operation coefficient used by the sound processing device to perform the signal processing for the audio signal is recorded beforehand as correlated with a distance between the speaker and the listening position,
the sound processing device reading the operation coefficient recorded in the recording device as correlated with the calculated distance, to perform the signal processing by utilizing the operation coefficient.

8. The sound reproduction apparatus according to claim 1, wherein the sound processing device performs the signal processing for altering a delay time, a sound pressure level, and a frequency characteristic of each of the audio signals based on the calculated distance.

9. The sound reproduction apparatus according to claim 1, wherein the display control device draws an icon that represents a listener as the selected image at a location that corresponds to the listening position in the sound field space, and draws an icon that represents the speaker as the selected image at a location that corresponds to an arranged position of each speaker.

10. A method of reproducing sound in a sound reproduction system comprising a plurality of speakers and a sound reproduction apparatus for causing each of the speakers that corresponds to each of a plurality of audio signals to loud-speak based on the plurality of audio signals, the method comprising:
a first process, by the sound reproduction apparatus, which causes a display device to display a setting screen which is a screen to display a virtual space that recreates the sound field space and on which a selected image is drawn at a listening position of the listener and a location that corresponds to a position where each of the speakers is arranged in the sound field space;
a second process, by the sound reproduction apparatus, which alters the setting screen in accordance with an input operation performed by a user based on the setting screen;
a third process, by the sound reproduction apparatus, which recognizes a set state of each of the speakers and a set state of the listening position in the virtual space based on the setting screen;
a fourth process, by the sound reproduction apparatus, which calculates an actual distance between each of the speakers and the listening position in the sound field space based on a result of the recognition; and
a fifth process, by the sound reproduction apparatus, which performs the signal processing that corresponds to the calculated distance for the audio signals.

11. A method of reproducing sound in a sound reproduction system comprising a plurality of speakers, a sound reproduction apparatus for causing each of the speakers that corresponds to each of a plurality of audio signals to loud-speak based on the plurality of audio signals, and an information processing apparatus for performing various kinds of signal processing, the method comprising:
an eleventh process, by the information processing apparatus, which causes a display device to display a setting screen which is a screen to display a virtual space that recreates the sound field space and on which a selected image is drawn at a listening position of the listener and a location that corresponds to a position where each of the speakers is arranged in the sound field space;
a twelfth process, by the information processing apparatus, which alters the setting screen in accordance with an input operation performed by a user based on the setting screen;
a thirteenth process, by the information processing apparatus, which recognizes a set state of each of the speakers and a set state of the listening position in the virtual space based on the setting screen;
a fourteenth process, by the information processing apparatus, which calculates an actual distance between each of the speakers and the listening position in the sound field space based on a result of the recognition;
a fifteenth process, by the information processing apparatus, which controls the sound reproduction apparatus in accordance with a result of the calculation; and
a sixteenth process, by the sound reproduction apparatus, which performs the signal processing that corresponds to the calculated distance for the audio signals under the control of the information processing apparatus.
